(19) United States
(12) Patent Application Publication
(10) Pub. No.: US 2024/0321134 A1
(43) Pub. Date: Sep. 26, 2024

(54) MOOD INFORMATION PRESENTATION TOOL, COVER FOR MOOD INFORMATION PRESENTATION TOOL, AND PAPER PATTERN FOR MOOD INFORMATION PRESENTATION TOOL

(71) Applicant: NIPPON TELEGRAPH AND TELEPHONE CORPORATION, Tokyo (JP)

(72) Inventors: Naomi WATANABE, Tokyo (JP); Tessei KOBAYASHI, Tokyo (JP)

(73) Assignee: NIPPON TELEGRAPH AND TELEPHONE CORPORATION, Tokyo (JP)

(21) Appl. No.: 18/022,721

(22) PCT Filed: Aug. 28, 2020
(86) PCT No.: PCT/JP2020/032556

§ 371 Date: Dec. 28, 2023

(51) Int. Cl. G09B 19/00; A63H 33/00

(52) U.S. Cl. CPC G09B 19/00; A63H 33/00

(57) ABSTRACT

To support an infant's ability to understand and present moods. A mood information presentation tool (10) is a three-dimensional object that is an approximately regular hexahedron. Six faces of a surface of the three-dimensional object include at least a mood selection surface (100) and four mood degree selection surfaces (110, 120, 130, and 140). The mood selection surface (100) includes four mood regions. Each of the mood regions is made up of a mood face region displaying a picture simulating a face of different mood and a mood background region to which is given a predetermined basic color as a color corresponding to the mood. Each of the mood degree selection surfaces (110, 120, 130, and 140) is a surface which is in contact with one mood region of the mood selection surface (100), which is given the basic color given to the mood background region of the mood region, and which includes a set of a plurality of signs representing degrees of mutually different magnitudes.

### TECHNICAL FIELD

The present invention relates to a technique for supporting emotional development of an infant or, in other words, an infant's ability to understand and present his/her moods.

### BACKGROUND ART

As a technique for supporting emotional development by visualizing mood, for example, a “Mood Meter” disclosed in Non-Patent Literature 1 and Non-Patent Literature 2 is known. The Mood Meter represents mood by a position on a two-dimensional graph with pleasantness as the horizontal axis and a magnitude of energy as the vertical axis. In each of four regions divided by the horizontal axis and the vertical axis, the upper right region corresponds to joy, the upper left region corresponds to anger, the lower right region corresponds to pleasure, and the lower left region corresponds to sorrow. The upper right region is based on yellow, the upper left region is based on red, the lower right region is based on green, the lower left region is based on blue, an entirety of each region may have the same color as in Non-Patent Literature 1 or each region may be further divided into a plurality of rectangular partial regions surrounded by vertical lines and horizontal lines as in Non-Patent Literature 2, and each partial region may adopt different luminance or saturation in a same basic color. Non-Patent Literature 3 describes that there is a possibility that a child will come to understand his/her mood by having the child attach a magnet to a portion of the Mood Meter representing his/her current mood and label by himself/herself his/her mood when the child enters a room.

### PRIOR ART LITERATURE

### Non-Patent Literature

Non-Patent Literature 1: Emotionally Intelligent School, LLC, “The Mood Meter”, [online], [retrieved: May 28, 2020], Internet <URL: https://apps.apple.com/jp/app/id825930113?ign-mpt=uo% 3D4>
Non-Patent Literature 2: Teachers Pay Teachers, “Mood Meter: A Socio-Emotional Resource”, [online], [retrieved: May 28, 2020], Internet <URL: https://www.teacherspayteachers.com/Product/Mood-Meter-A-Socio-Emotional-Resource-3207663>
Non-Patent Literature 3: Hiroshi Koga@ Minna no Seicho Oendancho (Cheerleader for Everyone's Growth), “Understanding Emotion Through Mood Meter”, [online], [retrieved: May 28, 2020], Internet <URL: https://note.com/kogamouse/n/n2efdac020ef8>

### SUMMARY OF THE INVENTION

### Problems to be Solved by the Invention

The Mood Meter can efficiently visualize the moods of joy, anger, sorrow, and pleasure. Further, Non-Patent Literature 3 suggests that a child may potentially come to understand his/her moods through the use of the Mood Meter. However, in the case of an infant who is not yet able to clearly categorize mood, there is a problem that it is difficult for the infant to present what kind of emotional state he/she is in even though given a Mood Meter and a magnet.

The present invention has been made in view of such a problem, and the objective is to provide a tool for supporting an infant's ability to understand and present his/her moods.

### Means to Solve the Problems

In order to solve the problem described above, a mood information presentation tool according to a first aspect of the present invention is a mood information presentation tool that is a three-dimensional object covering C (where C denotes an integer equal to or larger than 2) mood categories from first to C-th (referred to as a “c-th category”, where c denotes each integer that is 1 or more and C or less) , wherein a surface of the three-dimensional object includes at least a mood selection surface and C mood degree selection surfaces from a first mood degree selection surface to a C-th mood degree selection surface,
each of C basic colors from a first basic color to a C-th basic color (referred to as a “c-th basic color”) differ from one another,
the mood selection surface includes at least C mood regions from a first mood region to a C-th mood region which are approximately congruent regions including, in a contour, portions that differ from one another but with approximately a same length among a contour of the mood selection surface,
each of the C mood regions from the first mood region to the C-th mood region (referred to as a “c-th mood region”) is made up of a c-th mood face region which is a region displaying a picture simulating a face when experiencing a mood of the c-th category being a mood category which the c-th mood region corresponds to and a c-th mood background region which is a region to which a c-th basic color is given,
the C mood degree selection surfaces from the first mood degree selection surface to the C-th mood degree selection surface are approximately congruent, and
each of the C mood degree selection surfaces from the first mood degree selection surface to the C-th mood degree selection surface is a surface which is in contact with a c-th mood region of the mood selection surface, which is given the c-th basic color, and which includes a set of a plurality of signs representing degrees of mutually different magnitudes.

A mood information presentation tool according to a second aspect of the present invention is a mood information presentation tool that is a three-dimensional object covering C (where C denotes an integer equal to or larger than 2) mood categories from first to C-th (referred to as a “c-th category”, where c denotes each integer that is 1 or more and C or less) , wherein
a surface of the three-dimensional object includes at least a mood selection surface region and C mood degree selection surface regions from a first mood degree selection surface region to a C-th mood degree selection surface region, each of C basic colors from a first basic color to a C-th basic color (referred to as a “c-th basic color”) differ from one another,
the mood selection surface region includes at least C mood regions from a first mood region to a C-th mood region which are approximately congruent regions including, in a contour, portions that differ from one another but with approximately a same length among a contour of the mood selection surface region,
each of the C mood regions from the first mood region to the C-th mood region (referred to as a “c-th mood region”) is made up of a c-th mood face region which is a region displaying a picture simulating a face when experiencing a mood of the c-th category being a mood category which the c-th mood region corresponds to and a c-th mood background region which is a region to which a c-th basic color is given,
the C mood degree selection surface regions from the first mood degree selection surface region to the C-th mood degree selection surface region are approximately congruent regions, and
each of the C mood degree selection surface regions from the first mood degree selection surface region to the C-th mood degree selection surface region is a surface region which is in contact with a c-th mood region of the mood selection surface region, which is given the c-th basic color, and which includes a set of a plurality of signs representing degrees of mutually different magnitudes.

### Effects of the Invention

By using the mood information presentation tool according to the present invention, an infant's ability to understand and present his/her moods can be enhanced.

### BRIEF DESCRIPTION OF THE DRAWINGS

FIG. 1 is a perspective view illustrating a mood information presentation tool 10 according to a first embodiment.

FIG. 2 is a developed view illustrating a surface of the mood information presentation tool 10 according to the first embodiment.

FIG. 3 is a diagram illustrating a mood selection surface 100 of the mood information presentation tool 10 according to the first embodiment.

FIG. 4 is a diagram illustrating a first mood degree selection surface 110 of the mood information presentation tool 10 according to the first embodiment and a first mood degree selection surface region 210 of a mood information presentation tool 20 according to the second embodiment.

FIG. 5 is a perspective view illustrating the mood information presentation tool 20 according to the second embodiment.

FIG. 6 is a developed view illustrating a surface of the mood information presentation tool 20 according to the second embodiment.

FIG. 7 is a diagram illustrating a mood selection surface 200 of the mood information presentation tool 20 according to the second embodiment.

FIG. 8 is a diagram illustrating a second mood selection surface 100′ of the mood information presentation tool 10.

FIG. 9 is a diagram illustrating a second mood selection surface 200′ of the mood information presentation tool 20.

FIG. 10 is a diagram illustrating a cover 11 for a mood information presentation tool according to the fourth embodiment.

### DETAILED DESCRIPTION OF THE EMBODIMENTS

A technical feature of the mood information presentation tool according to the present invention resides in the arrangement of each surface and/or each surface region and the expression of each surface and/or each surface region taking advantage of the face arrangement in a three-dimensional object, and having this technical feature enables the tool to support an infant's ability to understand and present his/her moods. Hereinafter, the mood information presentation tool, how to use the mood information presentation tool, and a cover and a paper pattern for manufacturing the mood information presentation tool will be described.

### First Embodiment

A mood information presentation tool 10 and how to use the same according to a first embodiment will be described.

### [Mood Information Presentation Tool 10]

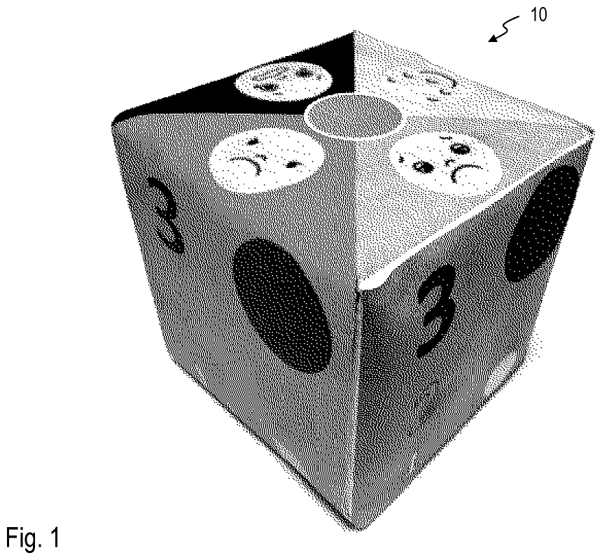

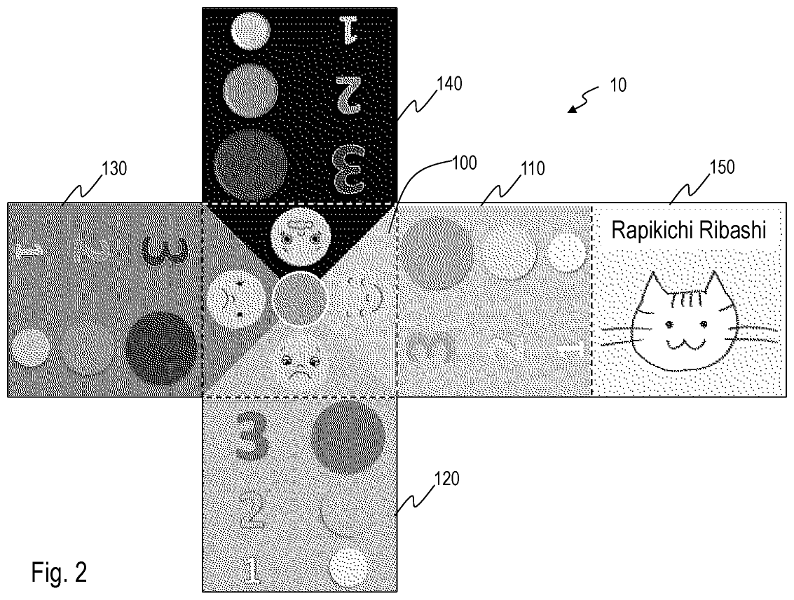

The mood information presentation tool 10 according to the first embodiment is a three-dimensional object having an approximately regular hexahedron shape of which a perspective view is illustrated in FIG. 1 and, as illustrated in a developed view in FIG. 2, the surface of the three-dimensional object has six approximately square faces including a mood selection surface 100, a first mood degree selection surface 110, a second mood degree selection surface 120, a third mood degree selection surface 130, a fourth mood degree selection surface 140, and a non-selection surface 150.

Dashed lines in the respective drawings are auxiliary lines drawn for convenience in explaining boundaries of surfaces, and dashed-dotted lines in the respective drawings are auxiliary lines drawn for convenience in explaining boundaries of regions. Since each auxiliary line is drawn for the purpose of convenience of explanation, not all boundaries are drawn by auxiliary lines. In addition, a part of the auxiliary lines is drawn not on a boundary line but in the vicinity of the boundary line in consideration of easy visual recognition. It is to be noted that terms prefixed with “approximate” such as “approximate regular hexahedron” and “approximate square” need only be perceived by an infant as such and strict adherence to the terms is not essential. Obviously, a concrete example of an “approximate regular hexahedron” is a “regular hexahedron”, a concrete example of an “approximate square” is a “square” and, similarly, a concrete example of terms prefixed with “approximate” described hereinafter is the terms obtained by removing the prefixed “approximate”. A similar argument also applies to each of the embodiments described later.

### [Material and Size of Mood Information Presentation Tool 10]

Although there is no limitation on a material of the mood information presentation tool 10, since the mood information presentation tool 10 is to be used by an infant himself/herself, it is preferable to make the mood information presentation tool 10 of a flexible material in consideration of the affinity of the infant and the carrying by the infant himself/herself, and for example, it is preferable to fill the inside with sponge, cotton, or air or to make the surface out of cloth. In addition, a size of the mood information presentation tool 10 is not limited as long as it is in a range operable by the infant himself/herself, but it is preferable that the infant himself/herself can easily carry and operate the mood information presentation tool 10 and, for example, each side is preferably set to about 9 cm.

### [Mood Selection Surface 100]

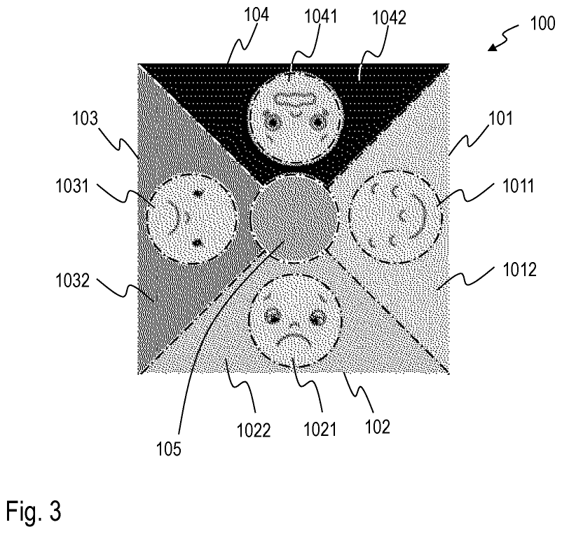

The mood selection surface 100 is a surface that allows the infant himself/herself to select one of four main moods, “happy”, “sad”, “angry”, and “scared, ” in other words, one of four main mood categories that an infant desirably comes to understand. As illustrated in FIG. 3, the mood selection surface 100 includes a first mood region 101, a second mood region 102, a third mood region 103, and a fourth mood region 104 and may include a neutral region 105.

The first mood region 101, the second mood region 102, the third mood region 103, and the fourth mood region 104 are approximately congruent regions (in other words, regions with approximately the same shape and approximately the same size) which include, in a contour thereof, approximately ¼ of a contour of the mood selection surface 100. More specifically, the first mood region 101, the second mood region 102, the third mood region 103, and the fourth mood region 104 are approximately congruent regions which include, as a side, one respectively different side among four sides shared by the mood selection surface 100 and each of the four surfaces in contact with the mood selection surface 100. When the mood selection surface 100 does not include the neutral region 105, for example, each of the first mood region 101, the second mood region 102, the third mood region 103, and the fourth mood region 104 is a region of an approximately right-angled isosceles triangle divided by two approximately diagonal lines of the mood selection surface 100. In addition, when the mood selection surface 100 includes the neutral region 105 as illustrated in FIG. 3, for example, the neutral region 105 is an approximately circular region centered on an approximate center of gravity (an intersection of diagonal lines) of the mood selection surface 100, and each of the first mood region 101, the second mood region 102, the third mood region 103, and the fourth mood region 104 is a region obtained by excluding a portion included in the neutral region 105 from a region of an approximately right-angled isosceles triangle divided by approximately diagonal lines of the mood selection surface 100.

The first mood region 101 is made up of a first mood face region 1011 which is a region where a picture simulating a face when “happy” is displayed and a first mood background region 1012 which is a region given a first basic color determined in advance as a color corresponding to the “happy” mood. The second mood region 102 is made up of a second mood face region 1021 which is a region where a picture simulating a face when “sad” is displayed and a second mood background region 1022 which is a region given a second basic color that differs from the first basic color and that is determined in advance as a color corresponding to the “sad” mood. The third mood region 103 is made up of a third mood face region 1031 which is a region where a picture simulating a face when “angry” is displayed and a third mood background region 1032 which is a region given a third basic color that differs from both the first basic color and the second basic color and that is determined in advance as a color corresponding to the “angry” mood. The fourth mood region 104 is made up of a fourth mood face region 1041 which is a region where a picture simulating a face when “scared” is displayed and a fourth mood background region 1042 which is a region given a fourth basic color that differs from the first basic color, the second basic color, and the third basic color and that is determined in advance as a color corresponding to the “scared” mood. That is, the first to fourth basic colors are different from one another.

The first mood face region 1011, the second mood face region 1021, the third mood face region 1031, and the fourth mood face region 1041 are preferably configured to prevent an infant from becoming interested in a part which is not characteristic of mood, the mood face regions are desirably approximately congruent regions (that is, regions with approximately a same shape and approximately a same size) , and a picture simulating a face to be displayed in each region is desirably a picture having a difference only in the characteristic of each mood. While each basic color is arbitrary, for example, preferably, each basic color is readily identifiable by the infant and a name of the color is readily utterable by the infant such as using yellow as the first basic color, blue as the second basic color, red as the third basic color, and black as the fourth basic color.

The neutral region 105 is a region which is given a fifth basic color determined in advance that differs from any of the first to fourth basic colors. The neutral region 105 may be an un-selectable region or may be a region used by the infant himself/herself to select a state that is neither “happy”, “sad”, “angry”, nor “scared”. When using the neutral region 105 as an un-selectable region, as illustrated in FIG. 3, the display of a picture simulating a face is not included. When the neutral region 105 is used by the infant himself/herself as a region to select a state that is neither “happy”, “sad”, “angry”, nor “scared”, the neutral region 105 may not include the display of a picture simulating a face or may display a picture simulating an “emotionless” face. When displaying a picture simulating an “emotionless” face in the neutral region 105, the neutral region 105 may be made up of a fifth mood face region which is a region where the picture simulating the “emotionless” face is displayed and a fifth mood background region which is a region given a fifth basic color determined in advance as a color corresponding to “emotionless”. An example of the fifth basic color is green. The fifth basic color when the neutral region 105 is used as a selectable region is preferably a color that is readily identifiable by the infant and a name of the color is preferably readily utterable by the infant in a similar manner to the first to fourth basic colors.

### [First Mood Degree Selection Surface 110, Second Mood Degree Selection Surface 120, Third Mood Degree Selection Surface 130, and Fourth Mood Degree Selection Surface 140]

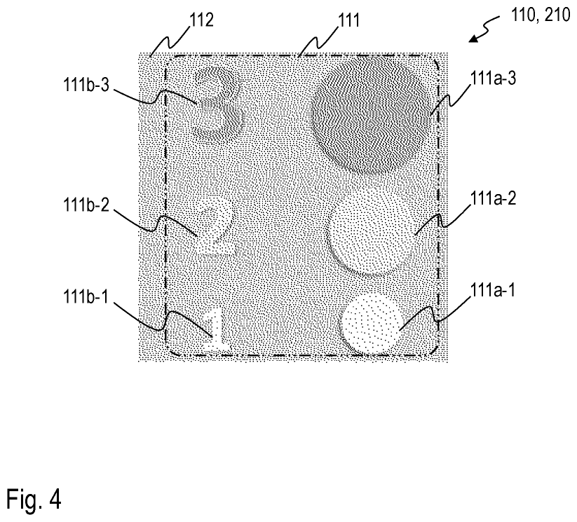

The first mood degree selection surface 110, the second mood degree selection surface 120, the third mood degree selection surface 130, and the fourth mood degree selection surface 140 are surfaces used by the infant himself/herself to select a magnitude of mood for the category selected by the infant himself/herself using the mood selection surface 100. Each of the first mood degree selection surface 110, the second mood degree selection surface 120, the third mood degree selection surface 130, and the fourth mood degree selection surface 140 is one of four surfaces in contact with the mood selection surface 100 among the six surfaces of the mood information presentation tool 10, and the surface includes, as a contour, a portion that is a contour of the mood region of a corresponding category among the contour of the mood selection surface 100. In other words, each of the first mood degree selection surface 110, the second mood degree selection surface 120, the third mood degree selection surface 130, and the fourth mood degree selection surface 140 is a surface which is one of four surfaces in contact with the mood selection surface 100 among the six surfaces of the mood information presentation tool 10 and which includes, as a side, a side that is also included in a contour of a mood region of a corresponding category among the four sides of the mood selection surface 100 (a surface which shares a side with a mood region of a corresponding category in the mood selection surface 100). The first mood degree selection surface 110, the second mood degree selection surface 120, the third mood degree selection surface 130, and the fourth mood degree selection surface 140 are approximately congruent. Hereinafter, the first mood degree selection surface 110 will be described in detail with reference to FIG. 4. The second mood degree selection surface 120, the third mood degree selection surface 130, and the fourth mood degree selection surface 140 only differ in each sign and a color of each region from the first mood degree selection surface 110 and have similar configurations and features to the first mood degree selection surface 110.

### [First Mood Degree Selection Surface 110]

The first mood degree selection surface 110 is a surface among four surfaces in contact with the mood selection surface 100 among six surfaces of the mood information presentation tool 10, and the surface includes a side included in the first mood region 101 among four sides of the mood selection surface 100 or, in other words, a surface in contact with the first mood region 101. The first mood degree selection surface 110 is made up of a first mood degree selection display 111 and a first mood degree selection background region 112. The first mood degree selection background region 112 is a region to which the same first basic color as the first mood background region 1012 of the mood selection surface 100 is given so that an infant can easily comprehend continuity with the “happy” mood region selected by the infant himself/herself by using the mood selection surface 100. The first mood degree selection display 111 is a display for the infant himself/herself to select a magnitude of the “happy” mood (that is, a degree of happiness or a measure of happiness) and includes a set of a plurality of signs representing magnitudes. The plurality of signs included in the set are signs showing degrees of mutually different magnitudes. It is preferable that the signs representing the degree of magnitude included in the set are “small” and “large” in the case of two and “small”, “medium” and “large” in the case of three so that the infant can easily make a selection.

An example of a set of a plurality of signs representing a magnitude is a set of a plurality of approximately similar graphics with mutually different sizes such as that shown on a right side of a portion enclosed by a two-dot chain line in FIG. 4 which is a set of three graphics including: a graphic 111a-1 with a predetermined first size and a predetermined shape (hereinafter, also referred to as a “small graphic”); a graphic 111a-2 with a predetermined second size that is larger than the first size and the predetermined shape (hereinafter, also referred to as a “medium graphic”); and a graphic 111a-3 with a predetermined third size that is larger than the second size and the predetermined shape (hereinafter, also referred to as a “large graphic”). Although the shape of the graphics is arbitrary, it is preferable that an infant can comprehend the shape without becoming greatly interested in the shape itself, and it is preferable to adopt a shape frequently used in a toy for an infant or the like such as a circle or a star shape. Also, as in the example shown in FIG. 4, the small graphic 111a-1, the medium graphic 111a-2, and the large graphic 111a-3 are preferably given a color (for example, a color obtained by differentiating a saturation of the first basic color) in a same color system as the color of the first mood degree selection background region 112 (in other words, the first basic color) and color intensities of the graphics are preferably set in an ascending order of the small graphic 111a-1, the medium graphic 111a-2, and the large graphic 111a-3.

Another example of a set of a plurality of signs representing a magnitude is a set of a plurality of mutually different numerical values such as that shown on a left side of the portion enclosed by the two-dot chain line in FIG. 4 which is a set of three numerals including: a numeral 111b-1 (hereinafter, also referred to as a “small numeral”) representing a predetermined first value; a numeral 111b-2 (hereinafter, also referred to as a “medium numeral”) representing a predetermined second value that is larger than the first value; and a numeral 111b-3 (hereinafter, referred to as a “large numeral”) representing a predetermined third value that is larger than the second value. While each predetermined value is arbitrary, a value which can be easily comprehended by an infant as much as possible is preferable, and as shown in the example of FIG. 4, when the small numeral 111b-1 is set to 1, the respective values are preferably incremented by one in an order of the small numeral 111b-1, the medium numeral 111b-2, and the large numeral 111b-3. In addition, as shown in FIG. 4, it is preferable that the sizes of the numerals become larger in the order of the small numeral 111b-1, the medium numeral 111b-2, and the large numeral 111b-3. Furthermore, as shown in FIG. 4, the small numeral 111b-1, the medium numeral 111b-2, and the large numeral 111b-3 are preferably given a color (for example, a color obtained by differentiating a saturation of the first basic color) in a same color system as the color of the first mood degree selection background region 112 (in other words, the first basic color) and color intensities of the numerals are preferably set in an ascending order of the small numeral 111b-1, the medium numeral 111b-2, and the large numeral 111b-3.

Still another example of a set of a plurality of signs representing a magnitude is a set of a plurality of groups of graphics of predetermined shapes of which numbers mutually differ such as a set made up of three groups including a group of a predetermined first number of (for example, one) graphics of predetermined shapes, a group of a predetermined second number of (for example, two) graphics of the predetermined shapes, the predetermined second number being larger than the first number, and a group of a predetermined third number of (for example, three) graphics of the predetermined shapes, the predetermined third number being larger than the second number. Shapes and colors of the graphics are preferably similar to those of the small graphic 111a-1, the medium graphic 111a-2, and the large graphic 111a-3 described above.

In the case where two signs, “small” and “large”, are used as a plurality of signs included in a set, a set of two graphics including a graphic with a predetermined first size and a predetermined shape and a graphic with a predetermined second size that is larger than the first size and the predetermined shape may be used as a set of two graphics with mutually different sizes and approximately similar shapes, a set of two numerals including a numeral (for example, 1) representing a predetermined first value and a second numeral (for example, 2) representing a predetermined second value that is larger than the first value may be used as a set of two mutually different numerical values, and a set of two groups of graphics of predetermined shapes including a group of a predetermined first number of (for example, one) graphics of predetermined shapes and a group of a predetermined second number of (for example, two) graphics of the predetermined shapes, the predetermined second number being larger than the first number, may be used as a set of two groups of graphics of predetermined shapes of which numbers mutually differ.

The first mood degree selection display 111 may include a plurality of sets of a plurality of signs representing a magnitude, and as shown in FIG. 4, a set of a plurality of graphics with approximately similar shapes and a set of a plurality of numbers having different values from each other may be included. That is, the first mood degree selection display 111 is a display for allowing the infant himself/herself to select a magnitude of the “happy” mood (that is, a degree of happiness or a measure of happiness) and is configured to include one or more sets of a plurality of signs representing a magnitude. However, when the first mood degree selection display 111 includes a plurality of sets of a plurality of signs representing a magnitude, it is desirable to equalize the number of signs representing a magnitude in all sets.

### [Second Mood Degree Selection Surface 120]

The second mood degree selection surface 120 is a surface among four surfaces in contact with the mood selection surface 100 among six surfaces of the mood information presentation tool 10, and includes a side included in the second mood region 102 among four sides of the mood selection surface 100 or, in other words, a surface in contact with the second mood region 102. The second mood degree selection surface 120 is made up of a second mood degree selection display and a second mood degree selection background region. The second mood degree selection background region is a region to which the same second basic color as the second mood background region 1022 of the mood selection surface 100 is given so that an infant can easily comprehend continuity with the “sad” mood region selected by the infant himself/herself by using the mood selection surface 100. The second mood degree selection display is a display for the infant himself/herself to select a magnitude of the “sad” mood (that is, a degree of sadness or a measure of sadness) and is configured to include one or more sets of a plurality of signs representing a magnitude in a similar manner to the first mood degree selection display 111 with the exception of being given a color of a same color system as the second basic color.

### [Third Mood Degree Selection Surface 130]

The third mood degree selection surface 130 is a surface among four surfaces in contact with the mood selection surface 100 among six surfaces of the mood information presentation tool 10, and includes a side included in the third mood region 103 among four sides of the mood selection surface 100 or, in other words, a surface in contact with the third mood region 103. The third mood degree selection surface 130 is made up of a third mood degree selection display and a third mood degree selection background region. The third mood degree selection background region is a region to which the same third basic color as the third mood background region 1032 of the mood selection surface 100 is given so that an infant can easily comprehend continuity with the “angry” mood region selected by the infant himself/herself by using the mood selection surface 100. The third mood degree selection display is a display for the infant himself/herself to select a magnitude of the “angry” mood (that is, a degree of anger or a measure of anger) and is configured to include one or more sets of a plurality of signs representing a magnitude in a similar manner to the first mood degree selection display 111 with the exception of being given a color of a same color system as the third basic color.

### [Fourth Mood Degree Selection Surface 140]

The fourth mood degree selection surface 140 is a surface among four surfaces in contact with the mood selection surface 100 among six surfaces of the mood information presentation tool 10, and includes a side included in the fourth mood region 104 among four sides of the mood selection surface 100 or, in other words, a surface in contact with the fourth mood region 104. The fourth mood degree selection surface 140 is made up of a fourth mood degree selection display and a fourth mood degree selection background region. The fourth mood degree selection background region is a region to which the same fourth basic color as the fourth mood background region 1042 of the mood selection surface 100 is given so that an infant can easily comprehend continuity with the “scared” mood region selected by the infant himself/herself by using the mood selection surface 100. The fourth mood degree selection display is a display for the infant himself/herself to select a magnitude of the “scared” mood (that is, a degree of fear or a measure of fear) and is configured to include one or more sets of a plurality of signs representing a magnitude in a similar manner to the first mood degree selection display 111 with the exception of being given a color of a same color system as the fourth basic color.

### <Non-Selection Surface 150>

The non-selection surface 150 is a surface not in contact with the mood selection surface 100 among the six surfaces of the mood information presentation tool 10. The non-selection surface 150 is a region that is given a predetermined sixth basic color which differs from the first basic color, the second basic color, the third basic color, the fourth basic color and the fifth basic color so as to prevent the infant from making an erroneous selection. For example, when each infant is to own the mood information presentation tool 10, the non-selection surface 150 may be used as a region for describing information for identifying an individual owner. FIG. 4 illustrates an example using a cat instead of an infant, where an owner name “Rapikichi Ribashi” and a portrait of the owner are shown. In this manner, by presenting information specifying the owner himself/herself in addition to differentiating the basic color of the non-selection surface 150 from other basic colors, an infant is prevented from making an erroneous selection when selecting a mood and a magnitude thereof. In the case where the neutral region 105 of the mood selection surface 100 is used as an un-selectable region, the basic color of the non-selection surface 150 (that is, the sixth basic color) may be the same as the basic color of the neutral region 105 (that is, the fifth basic color).

### [How to Use Mood Information Presentation Tool 10]

For example, it is preferable to use the mood information presentation tool 10 in the possession of each infant in the field of education or upbringing in a kindergarten, a day care, or the like. For example, upon or immediately after a situation (hereinafter, referred to as an “time of the event”) where an infant is expected to be experiencing or comprehending some kind of mood such as the four main moods described above like when there is a quarrel among infants, when a teacher or a caregiver reads a picture book to the infant and asks about a hero's/heroine's feelings, when the infant arrives at a kindergarten or a day care but finds it difficult to be separated from his/her parents, when the infant experiences emotional turmoil and struggles to convey his/her feelings with words, the teacher (that is, an educator) or a caregiver (that is, an up-bringer) instructs the infant to present his/her mood using the mood information presentation tool 10 in an order of step S1-1 and step S2-1 described later. It doesn't matter, in a scene where the mood information presentation tool 10 is used, whether the instructor is a teacher, a caregiver, or neither a teacher nor a caregiver but someone who provides education or childcare at the time concerned, and since anyone who provides an objective infant with education or childcare in that scene will suffice, hereinafter, a collective notation of “educator/up-bringer” will be used.

### [Instruction to Select Mood Category (Step S1-1)]

The educator/up-bringer points at the mood selection surface 100 toward an infant subject to instruction (hereinafter, also referred to as an “objective infant”) and instruct the objective infant to indicate which mood the objective infant had experienced at the time of the event or, in other words, to point at a region corresponding to the mood category at the time of the event from the four regions including the first mood region 101, the second mood region 102, the third mood region 103, and the fourth mood region 104 of the mood selection surface 100 when the neutral region 105 of the mood selection surface 100 is an un-selectable region or from the five regions including the first mood region 101, the second mood region 102, the third mood region 103, the fourth mood region 104, and the neutral region 105 when the neutral region 105 of the mood selection surface 100 is a selectable region. For example, the educator/up-bringer instructs the objective infant by asking “How are you feeling right now? Can you tell me by the face?”

### [Selection of Mood (Step S1-2)]

In accordance with the instruction from the educator/up-bringer in step S1-1, the objective infant indicates which mood he/she had experienced at the time of the event, in other words, points at a mood category at the time of the event. When the educator/up-bringer points at the mood selection surface 100, the objective infant focuses on the mood selection surface 100. Consequently, the first mood degree selection surface 110, the second mood degree selection surface 120, the third mood degree selection surface 130, and the fourth mood degree selection surface 140 which are surfaces perpendicular to the mood selection surface 100 become difficult to be visually recognized from the objective infant. Therefore, by using the mood information presentation tool 10 according to the present invention, the objective infant can concentrate on the selection of a mood category using the mood selection surface 100. Further, since pictures simulating a face are present in at least the first mood region 101, the second mood region 102, the third mood region 103, and the fourth mood region 104 of the mood selection surface 100, the difficulty experienced by the objective infant when selecting a mood category can be reduced. Further, when the objective infant is lost in selection, the educator/up-bringer may: utter a category in terms of words such as “Happy?” or “Angry?”; instruct the objective infant to point at a facial expression associated with a category such as “Which one is a happy face?” or “Which one is an angry face?”; ask the objective infant using onomatopoeia or mimic words associated with a category such as “Feeling ha-ha?” or “Feeling grrr?”; or instruct the objective infant to utter a category associated with a facial expression by asking “What do you feel when your face is like this?” or the like.

[Instruction to Select Magnitude of Mood (step S2-1)]

The educator/up-bringer instructs the objective infant to point at a sign representing the magnitude of his/her mood at the time of the event for the selected category using the surface corresponding to the category selected in step S1-2 among the four surfaces of the first mood degree selection surface 110, the second mood degree selection surface 120, the third mood degree selection surface 130, and the fourth mood degree selection surface 140.

[Selection of Magnitude of Mood (step S2-2)]

The objective infant points at a magnitude of his/her mood at the time of the event for the selected category according to the instruction by the educator/up-bringer in step S2-1. Each of the first mood degree selection surface 110, the second mood degree selection surface 120, the third mood degree selection surface 130, and the fourth mood degree selection surface 140 is in contact with each corresponding region on the mood selection surface 100, the first mood region 101, the second mood region 102, the third mood region 103, and the fourth mood region 104, and has the same basic color.

Therefore, by using the mood information presentation tool 10, the objective infant can easily move from step S1-2 to step S2-2. In addition, cases where it is difficult for the objective infant to make the selection of step S2-2 following the instruction by the educator/up-bringer in step S2-1 include a case where the selection of the category in step S1-2 had been erroneous. In such a case, preferably, the objective infant returns to step S1-2 to re-select a category and then move to step S2-2. Due to the mood information presentation tool 10 adopting the surface configuration and the basic color configuration described above, the objective infant can readily return from step S2-2 to step S1-2, re-select a category in step S1-2, and perform step S2-2 using a mood degree selection surface corresponding to the category after the re-selection. Further, the objective infant focuses on a surface corresponding to the selected category among the first mood degree selection surface 110, the second mood degree selection surface 120, the third mood degree selection surface 130, and the fourth mood degree selection surface 140. Consequently, since the surfaces other than the surface in focus are either perpendicular to the surface in focus or on the opposite side of the surface in focus, it is difficult for the objective infant to visually recognize other surfaces. Therefore, by using the mood information presentation tool 10, the objective infant can concentrate on selecting a magnitude of a mood using a surface corresponding to the selected category among the first mood degree selection surface 110, the second mood degree selection surface 120, the third mood degree selection surface 130, and the fourth mood degree selection surface 140.

The mood information presentation tool 10 can be used toward a group of infants such as a whole class of a kindergarten or a day care as an objective. In steps S1-1 and S1-2, for example, an educator/up-bringer may ask the whole class “How are you all feeling right now?” to have each objective infant belonging to the class point at a mood category representing his/her own mood among the mood selection surface 100 of his/her own mood information presentation tool 10 and show it to the educator/up-bringer. Alternatively, for example, while the educator/up-bringer is reading a picture book to the whole class, the educator/up-bringer may ask the whole class “What do you think he/she (hero/heroine) is feeling right now?” to have each objective infant belonging to the class point at a mood category which the objective infant thinks represents a mood of the hero/heroine in the mood selection surface 100 of his/her own mood information presentation tool 10 and show it to the educator/up-bringer.

Depending on an infant, in step S1-2, the infant may possibly indicate mood category representing his/her mood at the time of the event by showing or pointing at one of the first to fourth mood degree selection surfaces 110, 120, 130, and 140 toward the educator/up-bringer instead of pointing at any of the mood regions on the mood selection surface 100. In addition, depending on an infant, when the educator/up-bringer performs step S1-1, the infant himself/herself may advance to step S2-2 to point out, to the educator/up-bringer, a magnitude of mood in a mood degree selection surface among the first to fourth mood degree selection surfaces 110, 120, 130, and 140. These actions correspond to a developed understanding of mood by an infant or a developed ability of the infant to present moods through the use of the mood information presentation tool 10, and when the mood information presentation tool 10 is used toward a group as an objective, such actions can be expected to lead to the promotions of the mood understanding/presentation by the other infants who saw an infant moving to the mood degree selection surface. Therefore, it is desirable for the educator/up-bringer to permit such actions and to instruct how to use the mood information presentation tool 10 as needed in accordance with the development of infants.

### Second Embodiment

Although the mood information presentation tool 10 according to the first embodiment is configured to use one surface when an infant himself/herself selects a magnitude of mood, the mood information presentation tool may be configured to use a region extending over two surfaces across a side when the infant himself/herself selects a magnitude of mood. This aspect will now be described as a second embodiment.

### [Mood Information Presentation Tool 20]

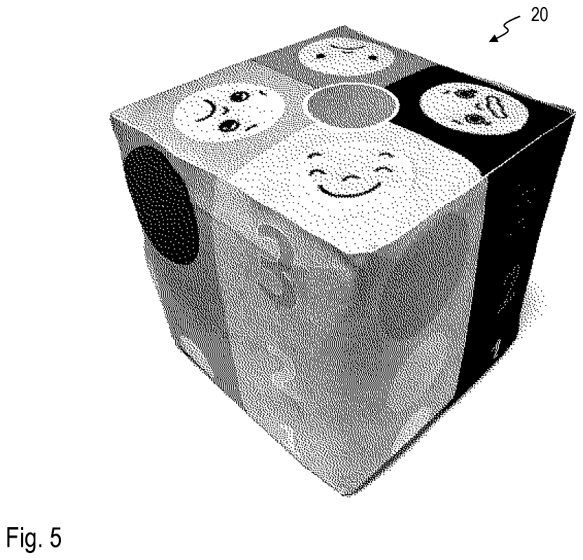

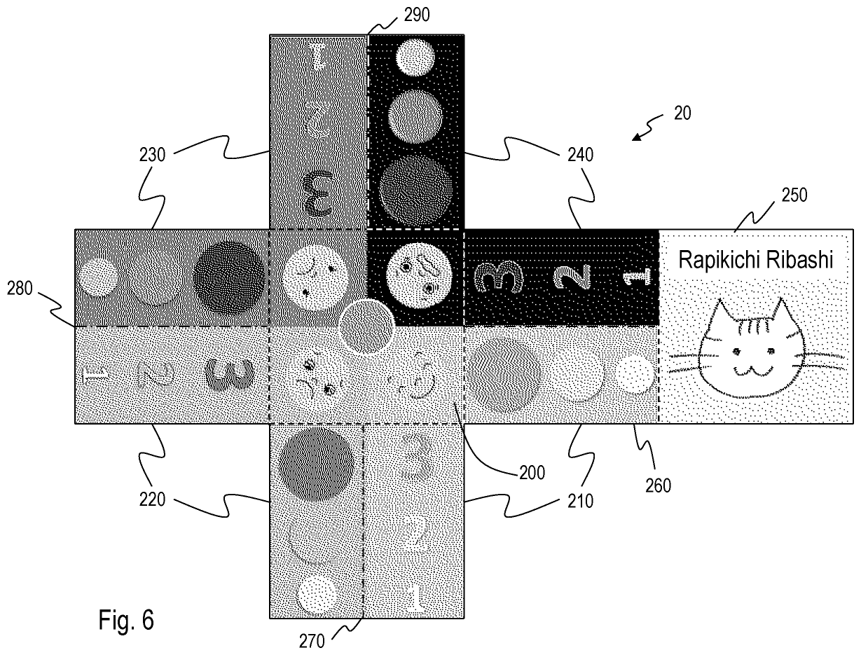

The mood information presentation tool 20 according to the second embodiment is a three-dimensional object having an approximately regular hexahedron shape of which a perspective view is illustrated in FIG. 5 and, as illustrated in a developed view in FIG. 6, a surface of the three-dimensional object has six approximately square faces including a mood selection surface 200, a degree selection first surface 260, a degree selection second surface 270, a degree selection third surface 280, a degree selection fourth surface 290, and a non-selection surface 250.

### [Material and Size of Mood Information Presentation Tool 20]

A material and a size of the mood information presentation tool 20 are similar to those of the mood information presentation tool 10 according to the first embodiment.

### [Mood Selection Surface 200]

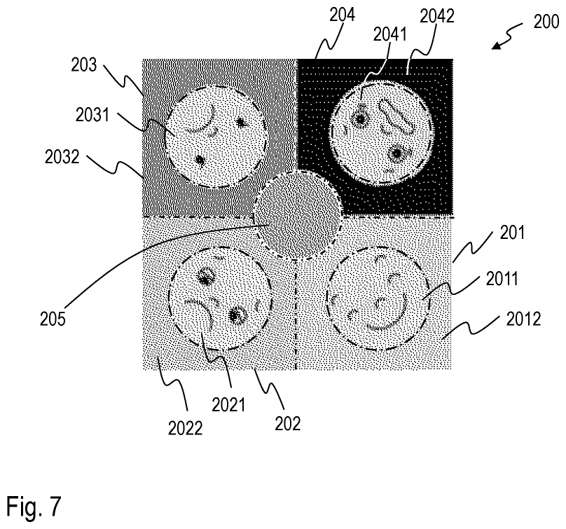

In a similar manner to the mood selection surface 100 according to the first embodiment, the mood selection surface 200 is a surface that allows an infant himself/herself to select one of four main moods “happy”, “sad”, “angry”, and “scared,” in other words a mood category, that an infant desirably comes to understand. As illustrated in FIG. 7, the mood selection surface 200 includes a first mood region 201, a second mood region 202, a third mood region 203, and a fourth mood region 204 and may include a neutral region 205.

The first mood region 201, the second mood region 202, the third mood region 203, and the fourth mood region 204 are approximately congruent regions (in other words, regions with approximately the same shape and approximately the same size) which include, in a contour thereof, approximately ¼ of a contour of the mood selection surface 200 in a similar manner to the first mood region 101, the second mood region 102, the third mood region 103, and the fourth mood region 104 according to the first embodiment. More specifically, the first mood region 201, the second mood region 202, the third mood region 203, and the fourth mood region 204 are approximately congruent regions which include, as a contour, a set (a respectively different set) made up of two adjacent line segments interposing a vertex among eight line segments approximately bisecting each of four sides shared by the mood selection surface 200 and each of the four surfaces in contact with the mood selection surface 200. When the mood selection surface 200 does not include the neutral region 205, for example, each of the first mood region 201, the second mood region 202, the third mood region 203, and the fourth mood region 204 is an approximately square region divided by two line segments connecting approximately middle points of opposite sides of the mood selection surface 200. In addition, when the mood selection surface 200 includes the neutral region 205 as illustrated in FIG. 7, for example, the neutral region 205 is an approximately circular region centered on an approximate center of gravity (an intersection of diagonal lines) of the mood selection surface 200, and each of the first mood region 201, the second mood region 202, the third mood region 203, and the fourth mood region 204 is a region obtained by excluding a portion included in the neutral region 205 from an approximately square region divided by two line segments connecting approximately middle points of opposite sides of the mood selection surface 200.

The first mood region 201, the second mood region 202, the third mood region 203, and the fourth mood region 204 are similar to the first mood region 101, the second mood region 102, the third mood region 103, and the fourth mood region 104 according to the first embodiment with the exception of having different shapes. That is, in a similar manner to the first embodiment, the first mood region 201 is made up of a first mood face region 2011 and a first mood background region 2012, the second mood region 202 is made up of a second mood face region 2021 and a second mood background region 2022, the third mood region 203 is made up of a third mood face region 2031 and a third mood background region 2032, the fourth mood region 204 is made up of a fourth mood face region 2041 and a fourth mood background region 2042, and each mood face region and each mood background region are similar to each mood face region and each mood background region according to the first embodiment.

The neutral region 205 is similar to the neutral region 105 according to the first embodiment.

### [First Mood Degree Selection Surface Region 210, Second Mood Degree Selection Surface Region 220, Third Mood Degree Selection Surface Region 230, and Fourth Mood Degree Selection Surface Region 240]

The first mood degree selection surface region 210, the second mood degree selection surface region 220, the third mood degree selection surface region 230, and the fourth mood degree selection surface region 240 are similar to the first mood degree selection surface 110, the second mood degree selection surface 120, the third mood degree selection surface 130, and the fourth mood degree selection surface 140 according to the first embodiment and are surface regions used by the infant himself/herself to select a magnitude of mood of a category selected by the infant himself/herself using the mood selection surface 200. Each of the first mood degree selection surface region 210, the second mood degree selection surface region 220, the third mood degree selection surface region 230, and the fourth mood degree selection surface region 240 is a region extending over two adjacent surfaces among four surfaces in contact with the mood selection surface 200 among six surfaces of the mood information presentation tool 20 and is a surface region including, as a contour, a portion that is a contour of the mood region of a corresponding category among the contour of the mood selection surface 200. The first mood degree selection surface region 210, the second mood degree selection surface region 220, the third mood degree selection surface region 230, and the fourth mood degree selection surface region 240 are approximately congruent regions.

### [First Mood Degree Selection Surface Region 210]

The first mood degree selection surface region 210 is a region extending over the degree selection first surface 260 and the degree selection second surface 270, and is a surface region including, as a contour, a portion being a contour of the first mood region 201 among the contour of the mood selection surface 200 or, in other words, a surface region in contact with the first mood region 201. As can be understood from the fact that flattening the first mood degree selection surface region 210 by the part bended at a boundary line between the degree selection first surface 260 and the degree selection second surface 270 replicates the first mood degree selection surface 110 according to the first embodiment shown in FIG. 4, a configuration and a feature of the first mood degree selection surface region 210 are similar to those of the first mood degree selection surface 110 according to the first embodiment.

### [Second Mood Degree Selection Surface Region 220]

The second mood degree selection surface region 220 is a region extending over the degree selection second surface 270 and the degree selection third surface 280, and is a surface region including, as a contour, a portion being a contour of the second mood region 202 among the contour of the mood selection surface 200 or, in other words, a surface region in contact with the second mood region 202. As can be understood from the fact that flattening the second mood degree selection surface region 220 by the part bended at a boundary line between the degree selection second surface 270 and the degree selection third surface 280 replicates the second mood degree selection surface 120 according to the first embodiment, a configuration and a feature of the second mood degree selection surface region 220 are similar to those of the second mood degree selection surface 120 according to the first embodiment.

### [Third Mood Degree Selection Surface Region 230]

The third mood degree selection surface region 230 is a region extending over the degree selection third surface 280 and the degree selection fourth surface 290, and is a surface region including, as a contour, a portion being a contour of the third mood region 203 among the contour of the mood selection surface 200 or, in other words, a surface region in contact with the third mood region 203. As can be understood from the fact that flattening the third mood degree selection surface region 230 by the part bended at a boundary line between the degree selection third surface 280 and the degree selection fourth surface 290 replicates the third mood degree selection surface 130 according to the first embodiment, a configuration and a feature of the third mood degree selection surface region 230 are similar to those of the third mood degree selection surface 130 according to the first embodiment.

### [Fourth Mood Degree Selection Surface Region 240]

The fourth mood degree selection surface region 240 is a region extending over the degree selection fourth surface 290 and the degree selection first surface 260, and is a surface region including, as a contour, a portion being a contour of the fourth mood region 204 among the contour of the mood selection surface 200 or, in other words, a surface region in contact with the fourth mood region 204. As can be understood from the fact that flattening the fourth mood degree selection surface region 240 by the part bended at a boundary line between the degree selection fourth surface 290 and the degree selection first surface 260 replicates the fourth mood degree selection surface 140 according to the first embodiment, a configuration and a feature of the fourth mood degree selection surface region 240 are similar to those of the fourth mood degree selection surface 140 according to the first embodiment.

### <Non-Selection Surface 250>

The non-selection surface 250 is similar to the non-selection surface 150 according to the first embodiment.

### [How to Use Mood Information Presentation Tool 20]

How to use the mood information presentation tool 20 is similar to how to use the mood information presentation tool 10 according to the first embodiment, and the mood information tool 20 can be used by replacing each “mood degree selection surface” in how to use the mood information tool 10 according to the first embodiment with each “mood degree selection surface region”.

In the case of the mood information presentation tool 20, unlike the mood information presentation tool 10 according to the first embodiment, when focusing on a surface region corresponding to a selected category among the first mood degree selection surface region 210, the second mood degree selection surface region 220, the third mood degree selection surface region 230, and the fourth mood degree selection surface region 240, a part of surface regions other than the surface region in focus may come into view. However, since the surface regions other than the surface region in focus are narrow regions having a different basic color from the surface region in focus, it is unlikely that an objective infant focus on other surface regions. Therefore, by using the mood information presentation tool 20 instead of the mood information presentation tool 10 according to the first embodiment, the objective infant can similarly concentrate on the selection of a magnitude of mood using a surface region corresponding to a selected category among the first mood degree selection surface region 210, the second mood degree selection surface region 220, the third mood degree selection surface region 230, and the fourth mood degree selection surface region 240.

### Modifications to First Embodiment and Second Embodiment

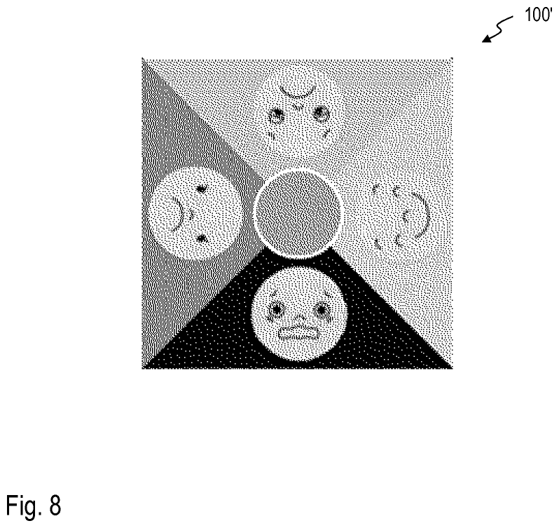

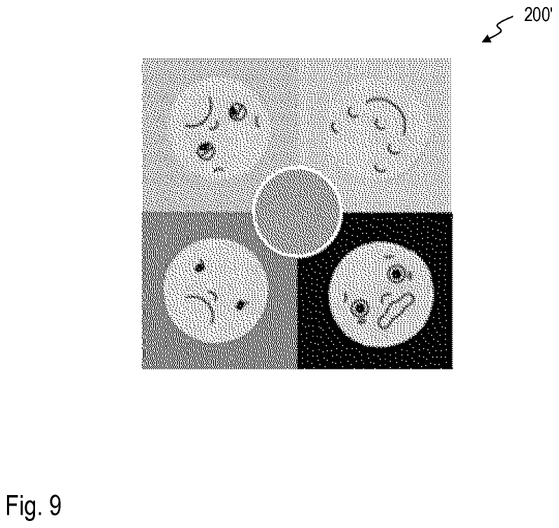

The mood information presentation tool 10 may include a second mood selection surface 100′ in place of the non-selection surface 150. The second mood selection surface 100′ may be a mirror image of the mood selection surface 100 as illustrated in FIG. 8, or may have a picture of each mood face region simulating a face turned upside down in a mirror image of the mood selection surface 100. A similar argument also applies to the mood information presentation tool 20 and the mood information presentation tool 20 may be provided with a second mood selection surface 200′ in place of the non-selection surface 250. The second mood selection surface 200′ may be a mirror image of the mood selection surface 200 as illustrated in FIG. 9, or may have a picture of each mood face region simulating a face turned upside down in a mirror image of the mood selection surface 200. The second mood selection surfaces 100′ and 200′ are for the infant himself/herself to select one of the four main mood categories in a similar manner to the mood selection surfaces 100 and 200.

### Third Embodiment

Although the mood information presentation tool 10 and the mood information presentation tool 20 described above cover the four main mood categories that an infant desirably comes to understand, a larger number of categories may be covered or a smaller number of categories may be covered, and the number of categories to be covered need only be a plurality. However, in this case, the mood information presentation tool is to be a three-dimensional object that is not an approximately regular hexahedron. In the present embodiment, a mood information presentation tool being a three-dimensional object that is not an approximately regular hexahedron will be described.

### First Example

A mood information presentation tool covering C (where C is an integer equal to or larger than 3) mood categories can be realized by, for example, a three-dimensional object that is an approximately regular C-gonal prism. This aspect will now be described as a first example. The mood information presentation tool includes one mood selection surface and C mood degree selection surfaces or C mood degree selection surface regions. The remaining one surface of the mood information presentation tool may be either a non-selection surface or a second mood selection surface.

### [Mood Selection Surface]

The mood selection surface is a surface for the infant himself/herself to select one of the C mood categories. The mood selection surface is one of two surfaces being an approximately regular C-gon that oppose each other among C+2 surfaces of an approximately regular C-gonal prism, includes C mood regions from first to C-th, and may include a neutral region. The C mood regions from first to C-th are approximately congruent regions (in other words, regions with approximately the same shape and approximately the same size) which include, in a contour thereof, approximately 1/C of a contour of the mood selection surface. For example, the C mood regions from first to C-th are approximately congruent regions including, as a side, one different side among C sides shared by the mood selection surface and each of C surfaces in contact with the mood selection surface. Alternatively, for example, the C mood regions from first to C-th are approximately congruent regions which include, as a contour, a set (a respectively different set) made up of two adjacent line segments interposing a vertex among 2C line segments approximately bisecting C sides shared by the mood selection surface and each of the C surfaces in contact with the mood selection surface.

Each of the C mood regions from first to C-th (hereinafter, also referred to as a “c-th mood region”, where c denotes an integer that is 1 or more and C or less) is made up of a c-th mood face region which is a region where a picture simulating a face expressing a mood of a category to which the c-th mood region corresponds is displayed and a c-th mood background region which is a region given a c-th basic color determined in advance as a color corresponding to the c-th category among first to C-th basic colors which differ from one another.

The neutral region is an approximately circular region centered on an approximate center of gravity (an intersection of diagonal lines) of the mood selection surface and given a predetermined C+1-th basic color which differs from any of the first to C-th basic colors, and a picture simulating an “emotionless” face may be displayed.

### [First to C-th Mood Degree Selection Surfaces]

The first to C-th mood degree selection surfaces are surfaces used by the infant himself/herself to select a magnitude of mood of a category selected by the infant himself/herself using the mood selection surface. Each of the first to C-th mood degree selection surfaces is one of C surfaces in contact with the mood selection surface among C+2 surfaces of the mood information presentation tool, and the surface includes, as a contour, a portion being a contour of the mood region of a corresponding category among the contour of the mood selection surface. Specifically, each of the first to C-th mood degree selection surfaces is a surface which is one of C surfaces in contact with the mood selection surface among the C+2 surfaces of the mood information presentation tool and which includes, as a side, a side that is included in a contour of a mood region of a corresponding category among the C sides of the mood selection surface (a surface which shares a side with a mood region of a corresponding category in the mood selection surface). The first to C-th mood degree selection surfaces are approximately congruent.

Each of the first to C-th mood degree selection surfaces (hereinafter, also referred to as a “c-th mood degree selection surface”) is made up of a c-th mood degree selection display and a c-th mood degree selection background region. The c-th mood degree selection background region is a region to which the same c-th basic color as that of the c-th mood background region of the mood selection surface is given, and is configured to include one or more sets of a plurality of signs representing a magnitude. An example of a set of a plurality of signs representing a magnitude is a set of a plurality of approximately similar graphics, a set of a plurality of numerical values that differ from one another, and a set of a plurality of groups of graphics of which numbers differ from one another. Each graphic or each numerical value included in each set may be displayed in different colors of a same color system as the c-th basic color such as a color having a different saturation of the c-th basic color.

### [First to C-th Mood Degree Selection Surface Regions]

The first to C-th mood degree selection surface regions are surface regions used by the infant himself/herself to select a magnitude of mood of a category selected by the infant himself/herself using the mood selection surface. The first to C-th mood degree selection surface regions are regions extending over two adjacent surfaces among C surfaces in contact with the mood selection surface among C+2 surfaces of the mood information presentation tool and are surface regions including, as a contour, a portion being a contour of the mood region of a corresponding category among the contour of the mood selection surface. The first to C-th mood degree selection surface regions are approximately congruent regions. A configuration and a feature in each of the first to C-th mood degree selection surface regions are similar to the configuration and the feature in each of the first to C-th mood degree selection surfaces.

### [Non-Selection Surface]

When the mood information presentation tool includes a non-selection surface, the non-selection surface is a surface not in contact with the mood selection surface among C+2 surfaces of the mood information presentation tool, and in order to prevent an infant from making an erroneous selection, the non-selection surface is a region given a predetermined C+2-th basic color that differs from any of the first to C+1-th basic colors when the neutral region of the mood selection surface is a selectable region, but the non-selection surface is a region given a predetermined C+1-th basic color that differs from any of the first to C-th basic colors when the mood selection surface does not include a neutral region. When the neutral region of the mood selection surface is an un-selectable region, the basic color of the non-selection surface may be the same as that of the neutral region of the mood selection surface.

### [Second Mood Selection Surface]

When the mood information presentation tool includes a second mood selection surface, the second mood selection surface is a surface not in contact with the mood selection surface among the C+2 surfaces of the mood information presentation tool and is a surface for the infant himself/herself to select any of the C mood categories in a similar manner to the mood selection surface. A feature of a configuration of the second mood selection surface is similar to that of the mood selection surface. However, since the second mood selection surface is a surface opposite the mood selection surface of the mood information presentation tool, the mood selection surface is a mirror image of the mood selection surface, has a picture simulating a face of each mood face region turned upside down in a mirror image of the mood selection surface, or the like.

### Second Example

A mood information presentation tool covering C (where C is an integer equal to or larger than 2) mood categories can be realized by, for example, a three-dimensional object that is an approximate sphere or an approximate rotational ellipsoid (approximate prolate spheroid). This aspect will now be described as a second example. The mood information presentation tool includes one mood selection surface region and C mood degree selection surface regions. The mood information presentation tool may include a non-selection surface region or a second mood selection surface region.

### [Mood Selection Surface Region]

The mood selection surface region is a surface for the infant himself/herself to select any of the C mood categories. The mood selection surface region is a surface region having a certain point on a surface of the mood information presentation tool as a center of gravity when the mood information presentation tool is an approximate sphere and a surface region having one point on a given rotational axis on the surface of the mood information presentation tool as a center of gravity when the mood information presentation tool is an approximate rotational ellipsoid, includes C mood regions from first to C-th, and may include a neutral region. The first to C-th mood regions are approximately congruent regions including, in a contour thereof, approximately 1/C of a contour of the mood selection surface region. For example, the C mood regions from first to C-th are approximately congruent regions including, as a side, one different side among C sides which each of C mood degree selection surface regions in contact with the mood selection surface region shares with the mood selection surface region. While an example of a shape of the mood selection surface region that enables each of the C mood regions to satisfy the conditions described above is a spherical shape of which a contour is a circle, the shape of the mood selection surface region may be any shape as long as each of the C mood regions satisfies the conditions described above. Each of the C mood regions is similar to each of the mood regions according to the first example with the exception of a shape and a size thereof. The neutral region is similar to the neutral region according to the first example with the exception of a shape and a size thereof.

### [First to C-th Mood Degree Selection Surface Regions]

The first to C-th mood degree selection surface regions are surface regions used by the infant himself/herself to select a magnitude of mood of a category selected by the infant himself/herself using the mood selection surface region. The first to C-th mood degree selection surface regions are C surface regions in contact with the mood selection surface region in the surface of the mood information presentation tool, and are approximately congruent surface regions including, as a contour, a portion being a contour of a mood region of a corresponding category among a contour of the mood selection surface region. Each mood degree selection surface region is similar to each mood degree selection surface region according to the first example with the exception of a shape and a size thereof.

### [Non-Selection Surface Region]

When the mood information presentation tool includes a non-selection surface region, the non-selection surface region is a surface region having, as a center of gravity, a point that is not a center of gravity of the mood selection surface region among two points on the surface of the mood information presentation tool on an axis passing the center of gravity of the mood selection surface region of the mood information presentation tool. The non-selection surface region is similar to the non-selection surface according to the first example with the exception of a shape and a size thereof.

### [Second Mood Selection Surface Region]

When the mood information presentation tool includes a second mood selection surface region, the second mood selection surface region is a surface region having, as a center of gravity, a point that is not a center of gravity of the mood selection surface region among two points on the surface of the mood information presentation tool on an axis passing the center of gravity of the mood selection surface region of the mood information presentation tool and is a surface for the infant himself/herself to select one of the C mood categories in a similar manner to the mood selection surface region. A feature of a configuration of the second mood selection surface region is similar to that of the mood selection surface region. However, since the second mood selection surface region is a surface region on the opposite side of the mood selection surface region of the mood information presentation tool, the second mood selection surface region is a mirror image of the mood selection surface region, has a picture simulating a face of each mood face region turned upside down in a mirror image of the mood selection surface region, is a surface region approximately similar to these surface regions, or the like.

### <Summary>

As can be understood from the description given above, a mood information presentation tool that covers C (where C denotes an integer equal to or larger than 2

) mood categories from first to C-th (referred to as a “c-th category”, where c denotes each integer that is 1

or more and C or less) includes, on a surface of a three-dimensional object, at least a mood selection surface region and C mood degree selection surface regions from a first mood degree selection surface region to a C-th mood degree selection surface region, wherein each of C basic colors (referred to as a “c-th basic color”) from a first basic color to a C-th basic color differ from one another,
the mood selection surface region includes at least C mood regions from a first mood region to a C-th mood region which are approximately congruent regions including, in a contour, portions that differ from one another but with approximately a same length among a contour of the mood selection surface region,
each of the C mood regions (referred to as a “c-th mood region”) from the first mood region to the C-th mood region is made up of a c-th mood face region which is a region displaying a picture simulating a face when experiencing a mood of the c-th category being a mood category which the c-th mood region corresponds to and a c-th mood background region which is a region to which the c-th basic color is given, the C mood degree selection surface regions from the first mood degree selection surface region to the C-th mood degree selection surface region are approximately congruent, and each of the C mood degree selection surface regions from the first mood degree selection surface region to the C-th mood degree selection surface region is a surface region which is in contact with a c-th mood region of the mood selection surface region, which is given the c-th basic color, and which includes a set of a plurality of signs representing degrees of mutually different magnitudes.

When the mood selection surface region and each of the C mood degree selection surface regions from a first mood degree selection surface region to a C-th mood degree selection surface region are constructed using a surface of a three-dimensional object, a mood information presentation tool that covers C (where C denotes an integer equal to or larger than 2) mood categories from first to C-th (referred to as a “c-th category”, where c denotes each integer that is 1 or more and C or less) includes, on a surface of the three-dimensional object, at least a mood selection surface and C mood degree selection surfaces from a first mood degree selection surface to a C-th mood degree selection surface, wherein
each of C basic colors from a first basic color to a C-th basic color (referred to as a “c-th basic color”) differ from one another,
the mood selection surface includes at least C mood regions from a first mood region to a C-th mood region which are approximately congruent regions including, in a contour, portions that differ from one another but with approximately a same length among a contour of the mood selection surface, each of the C mood regions from the first mood region to the C-th mood region (referred to as a “c-th mood region”) is made up of a c-th mood face region which is a region displaying a picture simulating a face when experiencing a mood of the c-th category being a mood category which the c-th mood region corresponds to and a c-th mood background region which is a region to which the c-th basic color is given,
the C mood degree selection surfaces from the first mood degree selection surface to the C-th mood degree selection surface are approximately congruent, and
each of the C mood degree selection surfaces from the first mood degree selection surface to the C-th mood degree selection surface is a surface which is in contact with a c-th mood region of the mood selection surface, which is given the c-th basic color, and which includes a set of a plurality of signs representing degrees of mutually different magnitudes.

As described above, the mood selection surface region need only include at least C mood regions from the first mood region to the C-th mood region which are approximately congruent regions including, in a contour thereof, mutually different portions with approximately the same length among a contour of the mood selection surface region, and the contour of the mood selection surface region may include a portion not in contact with any of the C mood degree selection surface regions from the first mood degree selection surface region to the C-th mood degree selection surface region. Similarly, the mood selection surface need only include at least C mood regions from the first mood region to the C-th mood region which are approximately congruent regions including, in a contour thereof, mutually different portions with approximately the same length among a contour of the mood selection surface, and the contour of the mood selection surface may include a portion not in contact with any of the C mood degree selection surfaces from the first mood degree selection surface to the C-th mood degree selection surface. More specifically, for example, the mood information presentation tool may be realized by a three-dimensional object being an approximate 2C-gonal prism of which C every other side surfaces among 2C side surfaces are approximately congruent and, in this case, the C approximately congruent side surfaces may be used as a first mood degree selection surface to a C-th mood degree selection surface and one of the bottom surfaces with an approximately 2C-gonal shape may be used as a mood selection surface.

### Fourth Embodiment

For example, if there is a three-dimensional object having approximately the same shape as that of the mood information presentation tool filled with sponge, cotton, or air, the mood information presentation tool according to each of the above-described embodiments can be produced by covering the three-dimensional object with a cover made of a material such as cloth.

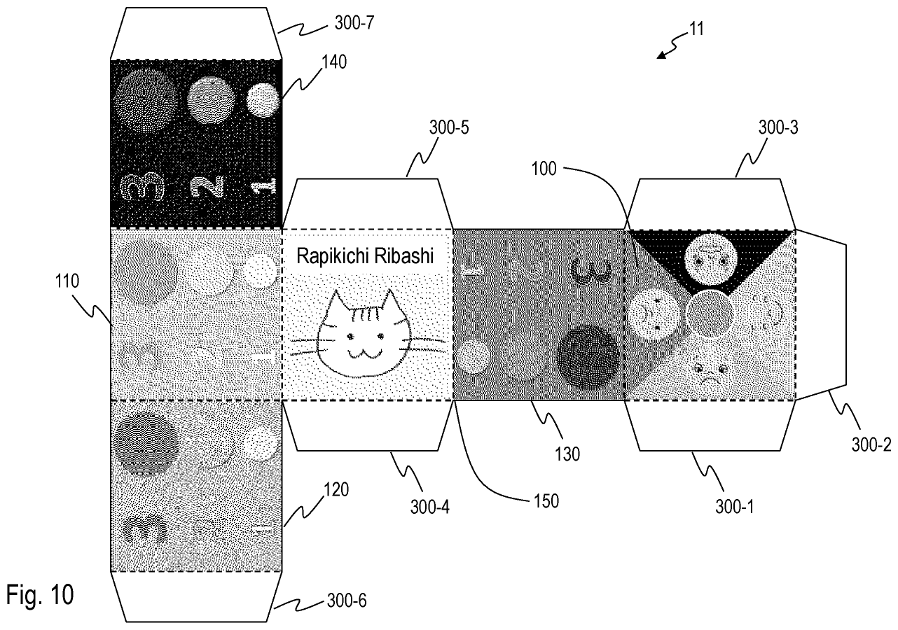

For example, in the case of a mood information presentation tool cover 11 for manufacturing the mood information presentation tool 10 according to the first embodiment, as illustrated in FIG. 10, the cover 11 may be configured to include: a surface made up of a developed view of the mood information presentation tool 10 and joining tabs 300-1 to 300-7 attached to one of two sides becoming a same side in the mood information presentation tool 10 among a contour of the developed view of the mood information presentation tool 10, wherein joining members that are readily joinable such as velcro tape are provided on the joining tabs 300-1 to 300-7 and on a rear surface of the developed view of the mood information presentation tool 10 which each joining tabs opposes. In addition, for example, in the case of a cover for a mood information presentation tool using a linear fastener, the joining tabs described above need not be provided and the cover may be configured to attach joinable linear fasteners to two sides that become a same side in the mood information presentation tool 10 among a contour of the developed view of the mood information presentation tool 10. The same applies to a mood information presentation tool cover for manufacturing the mood information presentation tool according to each of the embodiments and modifications described above. As can be understood from a comparison between FIG. 2 and FIG. 10, a developed view of a mood information presentation tool may be obtained by any development of the mood information presentation tool. That is, a cover for a mood information presentation tool may have a surface including at least a developed view of the mood information presentation tool and may include a joining mechanism for joining two sides to become a same side in the mood information presentation tool among the contour of the developed view. Since a cover for a mood information presentation tool need only be capable of producing the mood information presentation tool by joining two sides to become a same side in the mood information presentation tool among the contour of the developed view, the cover for a mood information presentation tool may be divided into a plurality of components having surfaces respectively including a plurality of partial views that make up the developed view.

### Fifth Embodiment

Preferably, an educator/up-bringer or the like can readily manufacture the mood information presentation tools according to the first to third embodiments and the modifications and the cover for a mood information presentation tool according to the fourth embodiment and, to this end, a paper pattern of any of a developed view of the mood information presentation tools according to the first to third embodiments and the modifications, a developed view of the cover for a mood information presentation tool according to the fourth embodiment, or a set of drawings which is obtained by dividing any of the developed views into a plurality of parts and which explicitly show joint portions may be made available by sales, delivery, distribution, or the like. Specifically, when a paper pattern printed on paper is to be made available by sales, delivery, distribution, or the like, a sheet of paper on which is printed at least any of a developed view of the mood information presentation tools according to the first to third embodiments and the modifications, a developed view of the cover for a mood information presentation tool according to the fourth embodiment, or a set of drawings which is obtained by dividing any of the developed views into a plurality of parts and which explicitly show joint portions may be made available as a paper pattern by sales, delivery, distribution, or the like. In addition, an electronic file of an image of at least any of the paper patterns may be recorded in a recording medium, for example a non-transitory recording medium such as a magnetic recording device or an optical disk, readable by a computer connected to a server computer, and the electronic file of the image of the paper pattern may be made available by transferring the electronic file of the image of the paper pattern from the server computer to another computer via a network. Furthermore, the electronic file of the image of at least any of the paper patterns may be recorded in a portable recording medium such as a DVD or a CD-ROM, and the electronic file of the image of the paper pattern may be made available by sales, transfer, lending, or the like of the portable recording medium. Obviously, in addition to a printed pattern paper and an electronic file of an image of the pattern paper, a set of fabric displaying each surface, each surface region, a plurality of successive surfaces, a plurality of successive surface regions, or the like by means of prints, embroidery, or the like may also be made available by sales, delivery, distribution, or the like.

It is needless to say that changes can be made as appropriate without departing from the gist of the present invention.

What is claimed is:

1. A mood information presentation tool being a three-dimensional object that is an approximately regular hexahedron, wherein
six faces of a surface of the three-dimensional object include at least a mood selection surface, a first mood degree selection surface, a second mood degree selection surface, a third mood degree selection surface, and a fourth mood degree selection surface,
the mood selection surface includes a first mood region, a second mood region, a third mood region, and a fourth mood region which are regions that include, as a side, one respectively different side among four sides shared by the mood selection surface and each of four surfaces in contact with the mood selection surface and which are approximately congruent regions,
the first mood region is made up of a first mood face region which is a region where a picture simulating a face when happy is displayed and a first mood background region which is a region given a first basic color determined in advance as a color corresponding to the mood of happiness,
the second mood region is made up of a second mood face region which is a region where a picture simulating a face when sad is displayed and a second mood background region which is a region given a second basic color determined in advance as a color corresponding to the mood of sadness,
the third mood region is made up of a third mood face region which is a region where a picture simulating a face when angry is displayed and a third mood background region which is a region given a third basic color that is determined in advance as a color corresponding to the mood of anger,
the fourth mood region is made up of a fourth mood face region which is a region where a picture simulating a face when scared is displayed and a fourth mood background region which is a region given a fourth basic color that is determined in advance as a color corresponding to the mood of fear,
the first basic color, the second basic color, the third basic color, and the fourth basic color are mutually different, the first mood degree selection surface is a surface in contact with the first mood region of the mood selection surface, which is given the first basic color, and which includes a set of a plurality of signs representing a degree of mutually different magnitudes,
the second mood degree selection surface is a surface in contact with the second mood region of the mood selection surface, which is given the second basic color, and which includes a set of a plurality of signs representing a degree of mutually different magnitudes,
the third mood degree selection surface is a surface in contact with the third mood region of the mood selection surface, which is given the third basic color, and which includes a set of a plurality of signs representing a degree of mutually different magnitudes, and
the fourth mood degree selection surface is a surface in contact with the fourth mood region of the mood selection surface, which is given the fourth basic color, and which includes a set of a plurality of signs representing a degree of mutually different magnitudes.

2. A mood information presentation tool being a three-dimensional object that is an approximately regular hexahedron, wherein
six faces of a surface of the three-dimensional object include at least a mood selection surface, a degree selection first surface, a degree selection second surface, a degree selection third surface, and a degree selection fourth surface,
the degree selection first surface is a surface in contact with the mood selection surface, the degree selection fourth surface, and the degree selection second surface,
the degree selection second surface is a surface in contact with the mood selection surface, the degree selection first surface, and the degree selection third surface,
the degree selection third surface is a surface in contact with the mood selection surface, the degree selection second surface, and the degree selection fourth surface,
the degree selection fourth surface is a surface in contact with the mood selection surface, the degree selection third surface, and the degree selection first surface,
the mood selection surface includes a first mood region, a second mood region, a third mood region, and a fourth mood region which are regions that include, as a contour, a set made up of two adjacent line segments interposing a vertex among eight line segments approximately bisecting each of four sides shared by the mood selection surface and each of the four surfaces in contact with the mood selection surface and which are approximately congruent regions,
the first mood region is made up of a first mood face region which is a region where a picture simulating a face when happy is displayed and a first mood background region which is a region given a first basic color determined in advance as a color corresponding to the mood of happiness,
the second mood region is made up of a second mood face region which is a region where a picture simulating a face when sad is displayed and a second mood background region which is a region given a second basic color determined in advance as a color corresponding to the mood of sadness,
the third mood region is made up of a third mood face region which is a region where a picture simulating a face when angry is displayed and a third mood background region which is a region given a third basic color that is determined in advance as a color corresponding to the mood of anger,
the fourth mood region is made up of a fourth mood face region which is a region where a picture simulating a face when scared is displayed and a fourth mood background region which is a region given a fourth basic color that is determined in advance as a color corresponding to the mood of fear,
the first basic color, the second basic color, the third basic color, and the fourth basic color are mutually different, a surface region which extends over the degree selection first surface and the degree selection second surface and which includes, as a contour, a portion being a contour of the first mood region among the contour of the mood selection surface is designated as a first mood degree selection surface region, a surface region which extends over the degree selection second surface and the degree selection third surface and which includes, as a contour, a portion being a contour of the second mood region among the contour of the mood selection surface is designated as a second mood degree selection surface region,
a surface region which extends over the degree selection third surface and the degree selection fourth surface and which includes, as a contour, a portion being a contour of the third mood region among the contour of the mood selection surface is designated as a third mood degree selection surface region, a surface region which extends over the degree selection fourth surface and the degree selection first surface and which includes, as a contour, a portion being a contour of the fourth mood region among the contour of the mood selection surface is designated as a fourth mood degree selection surface region,
the first mood degree selection surface region, the second mood degree selection surface region, the third mood degree selection surface region, and the fourth mood degree selection surface region are approximately congruent,
the first mood degree selection surface region is given the first basic color and includes a set of a plurality of signs representing a degree of mutually different magnitudes, the second mood degree selection surface region is given the second basic color and includes a set of a plurality of signs representing a degree of mutually different magnitudes,
the third mood degree selection surface region is given the third basic color and includes a set of a plurality of signs representing a degree of mutually different magnitudes, and the fourth mood degree selection surface region is given the fourth basic color and includes a set of a plurality of signs representing a degree of mutually different magnitudes.

3. A mood information presentation tool that is a three-dimensional object covering C (where C denotes an integer equal to or larger than 2) mood categories from first to C-th (referred to as a “c-th category”, where c denotes each integer that is 1 or more and C or less), wherein a surface of the three-dimensional object includes at least a mood selection surface and C mood degree selection surfaces from a first mood degree selection surface to a C-th mood degree selection surface,
each of C basic colors from a first basic color to a C-th basic color (referred to as a “c-th basic color”) differ from one another,
the mood selection surface includes at least C mood regions from a first mood region to a C-th mood region which are approximately congruent regions including, in a contour, portions that differ from one another but with approximately a same length among a contour of the mood selection surface, each of the C mood regions from the first mood region to the C-th mood region (referred to as a “c-th mood region”) is made up of a c-th mood face region which is a region displaying a picture simulating a face when experiencing a mood of the c-th category being a mood category which the c-th mood region corresponds to and a c-th mood background region which is a region to which a c-th basic color is given,
the C mood degree selection surfaces from the first mood degree selection surface to the C-th mood degree selection surface are approximately congruent, and
each of the C mood degree selection surfaces from the first mood degree selection surface to the C-th mood degree selection surface is a surface which is in contact with a c-th mood region of the mood selection surface, which is given the c-th basic color, and which includes a set of a plurality of signs representing degrees of mutually different magnitudes.

4. A mood information presentation tool that is a three-dimensional object covering C (where C denotes an integer equal to or larger than 2) mood categories from first to C-th (referred to as a “c-th category”, where c denotes each integer that is 1 or more and C or less) , wherein a surface of the three-dimensional object includes at least a mood selection surface region and C mood degree selection surface regions from a first mood degree selection surface region to a C-th mood degree selection surface region, each of C basic colors from a first basic color to a C-th basic color (referred to as a “c-th basic color”) differ from one another,
the mood selection surface region includes at least C mood regions from a first mood region to a C-th mood region which are approximately congruent regions including, in a contour, portions that differ from one another but with approximately a same length among a contour of the mood selection surface region,
each of the C mood regions from the first mood region to the C-th mood region (referred to as a “c-th mood region”) is made up of a c-th mood face region which is a region displaying a picture simulating a face when experiencing a mood of the c-th category being a mood category which the c-th mood region corresponds to and a c-th mood background region which is a region to which a c-th basic color is given,
the C mood degree selection surface regions from the first mood degree selection surface region to the C-th mood degree selection surface region are approximately congruent regions, and
each of the C mood degree selection surface regions from the first mood degree selection surface region to the C-th mood degree selection surface region is a surface region which is in contact with a c-th mood region of the mood selection surface region, which is given the c-th basic color, and which includes a set of a plurality of signs representing degrees of mutually different magnitudes.

5. The mood information presentation tool according to one of claims 1 to 4, wherein
the set of a plurality (hereinafter, referred to as “N”) of signs representing degrees of mutually different magnitudes are at least any of:
a set of N approximately similar graphics with mutually different sizes;
a set of N mutually different numerical values; and
a set of N groups of graphics of predetermined shapes of which numbers mutually differ.

6. A cover for a mood information presentation tool to cover a three-dimensional object in order to produce the mood information presentation tool according to one of claims 1 to 5, comprising:
a surface including at least a developed view of the mood information presentation tool; and
a joining mechanism for joining two sides that become a same side in the mood information presentation tool among a contour of the developed view.

7. A paper pattern for a mood information presentation tool, having a surface on which is printed at least any of a developed view of the mood information presentation tool according to any one of claims 1 to 5, a developed view of the cover for a mood information presentation tool according to claim 6, and a set of drawings which is obtained by dividing any of the developed views into a plurality of parts and which explicitly shows joint portions.

8. A paper pattern for a mood information presentation tool, being an electronic file on which is recorded an image of at least any of a developed view of the mood information presentation tool according to any one of claims 1 to 5, a developed view of the cover for a mood information presentation tool according to claim 6, and a set of drawings which is obtained by dividing any of the developed views into a plurality of parts and which explicitly shows joint portions.
